(19) United States
(12) Patent Application Publication
(10) Pub. No.: US 2009/0117515 A1
(43) Pub. Date: May 7, 2009

(54) INTERPROXIMAL MARKING STRAND

(76) Inventor: Richard Resk, Howard Beach, NY (US)

Correspondence Address: MALIN HALEY AND DIMAGGIO, PA, 1936 S ANDREWS AVENUE, FORT LAUDERDALE, FL, 33316, US

(21) Appl. No.: 11/935,521

(22) Filed: Nov. 6, 2007

(51) Int. Cl. A61C 5/11; A61C 13/38

(52) U.S. Cl. 433/70; 433/219

(57) ABSTRACT

A method and device for marking a natural tooth/bridge, crown or any dental restoration interface to mark high spots on said bridge or crown to be removed during the fitting process using a fiber or filament strand impregnated or otherwise treated with a visual indicating marker material. The marking device may include the use of handheld tool that includes at least one end having a wishbone shaped support for attaching the fiber or filament strand impregnated with the marker material between the wishbone support or having a tool having both ends with wishbone supports, both ends for supporting one or more filaments or strands of material that includes visual markers.

### BACKGROUND OF THE INVENTION

1. Field of the Invention

This invention relates to marking devices and more particularly relates to a fiber or filament strand impregnated or otherwise treated with a visual indicating marker adapted to be moved manually with or without a tool through the interproximal region of a natural tooth/bridge, crown or any dental restoration interface to mark “high” spots on said bridge or crown to be removed during the fitting process.

2. Description of Related Art

In the insertion of a crown or bridge, the remnants of a natural tooth or teeth are ground down, leaving a preparation. Upon the tooth preparation there is fitted either a crown or bridge. Because dentition varies from patient to patient, each crown must be custom fitted.

To this end, an impression is made of the region surrounding the tooth preparation and preparation dies are fabricated and placed within the impression. The crown is fabricated and an initial attempt is made to place the crown on the die, at which time it is customarily discovered that the interproximal space on either side of the crown needs to be modified, usually by removing material from the prepared crown because there are high spots, or raised areas of material which preclude the crown from fitting into the interproximal space. In order to locate these high spots, the practitioner has heretofore resorted to such implements as wedging carbonized paper between the crown and the proximal teeth so as to mark the high spot on the crown which must be reduced in order to attain a proper fit.

In practice, the practitioner passes dental floss between the crown and the proximal tooth on the impression to ascertain whether or not there is indeed a high spot. If there is, a marking means must thereafter be utilized, such as the carbon paper mentioned above, to pinpoint the high spots.

The instant invention has as its principal objective to eliminate the second step of marking separately from passing the dental floss to ascertain the location of high spots by combining the marking means with the dental floss or other fiber.

Impregnated dental floss or dental tape for cleaning the interproximal surfaces of teeth have heretofore been disclosed, such as that of U.S. Pat. No. 3,699,979 to Muhler, et al. or U.S. Pat. No. 3,491,776 to Fleming. No one, however, has combined the fibrous strand used to locate interproximal high spots with an element to locate and highlight said high spots.

### SUMMARY OF THE INVENTION

The device described herein facilitates the more accurate and less time consuming fitting of crowns and bridges in the mouth by the provision of a dental floss, fiber or strand impregnated, coated or otherwise treated with a high spot marker. The marker may be, for example, but not by way of limitation, food coloring, blue carbon or other chemical additives such as PENCRAFT Red Color-Tag made by Pentron Corporation of Wellingford, Conn. The use of the device described eliminates an entire step in the crown-fitting process, namely, that of placing bite paper or other markers between the crown and impression of the natural tooth, thereby reducing the time consumed and cost involved with crown and bridge work fitting.

Utilizing a marker in combination with a fibrous strand such as dental floss eliminates the step of placing bit paper between the crown and adjacent natural teeth to locate high spots, thus resulting in a significant time saving. One of the most significant advantages of this invention is the precise marking of a tooth so as to determine a specific contact arch. Carbonized paper does not allow the area to be reduced to be accurately marked. Such paper also suffers “smudging,” giving the operator a false mark.

It is a principal object of the invention to provide a combined dental fiber and high spot marker means in the form of a dental floss or other strand impregnated or otherwise treated with a marker.

It is another object of the invention to reduce the number of steps involved in inserting a crown or bridge in a mouth.

In accordance with these and other objects which will become apparent hereinafter, the instant invention will now be described with particular reference to the accompanying drawings.

### BRIEF DESCRIPTION OF THE DRAWINGS

FIG. 1 is a side elevational view of a section of the fibrous strand treated with a visual marking material showing the present invention.

FIG. 2 is a side elevational view of an impression of the mouth into which a crown is being installed showing the fibrous strand with marker of the instant invention in operative engagement in an interproximal region.

FIG. 3 is a perspective view of the impression of FIG. 2 showing the crown removed, thus revealing the marked raised area to be removed during the fitting procedure.

FIG. 4 shows a perspective view of an implement that can be handheld and used with the fibrous strand with the present invention.

FIG. 5 shows a perspective view of an alternate embodiment of the tool or implement shown in FIG. 4 that includes a double end, each end of which can hold one or more fibrous strands.

### PREFERRED EMBODIMENT OF THE INVENTION

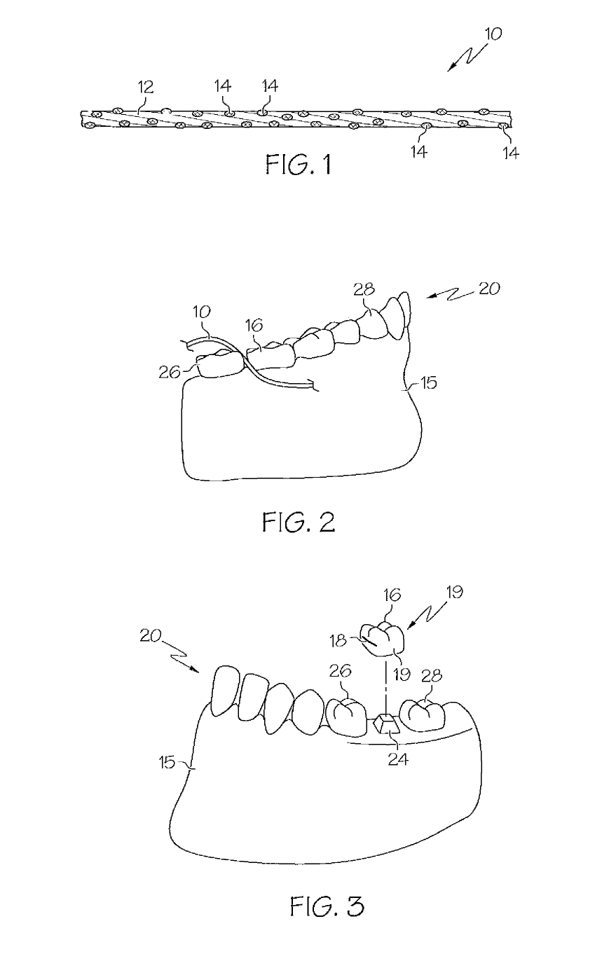

Referring to FIGS. 1, 2 and 3, this invention contemplates coating, impregnating or otherwise treating a continuous strand of mono or poly filament fiber 12 such as dental floss with a marking material 14 adapted to mark raised areas 18 on a porcelain restoration 16 such as a crown or bridge during the process of fitting such restoration into the mouth of a patient.

During the process of inserting a dental restoration to a pre-existing natural tooth, an impression 20 of the area to be treated is taken. Said impression replicates the teeth adjacent the tooth to receive the restoration so that the process of fitting said restoration 16 to the preparation 24 (FIG. 3) can be carried out outside of the patient's mouth. After the restoration 16 is prepared, inevitably in most cases, there are raised areas 18 located on the interproximal surfaces 19 of the restoration 16 which will contact the corresponding interproximal surfaces of the adjacent teeth 26 and 28. Mere visual inspection has proven insufficient to locate exactly where raised areas 18 are.

The invention includes a structure and method of detecting the presence of these raised areas 18 while simultaneously marking areas 18 so that the raised areas 18 may be removed by sanding or other method. Once the restoration 16 is prepared and is capable of being placed between adjacent teeth 26 and 28, the fiber 10, as best shown in FIG. 2, is passed through the interproximal region between restoration 16 and first adjacent tooth 26 and next adjacent tooth 28 whereupon any raised areas 18 are marked by marking material 14 which is impregnated within or along fibrous strand 12. Once marked, the restoration 16 may be removed from the temporary preparation 24 and the raised areas 18 eliminated. The restoration is replaced upon the temporary restoration 24 and fiber 10 is again passed through said interproximal spaces and any additional or residual raised areas 18 are marked by passing fiber 10 through said interproximal spaces again.

Once the restoration 16 has been sized to fit properly within the space between teeth 26 and 28, said restoration 16 may be simply inserted in the conventional manner within the patient's mouth (not shown) upon a preparation (not shown ) identical or similar to preparation 24.

Marking material 14 may be comprised of food coloring, blue or other powdered carbon or any other chemical additive such as PENCRAFT Red Color-Tag distributed by the Pentron Corporation of Wellingford, Conn. Another suitable marking material is known as Gresmark distributed by Gresco Products of Staford, Tex. Of course, any other suitable marking medium capable of adhering to common dental floss and of marking the restoration material, commonly a porcelain based composition, may be used as the marking medium.

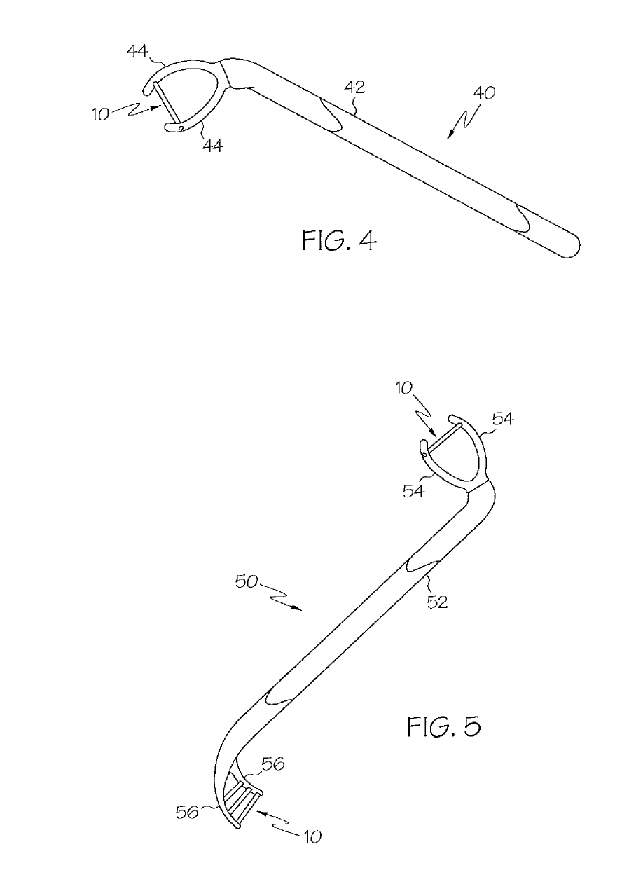

Referring now to FIG. 4, a tool or implement 40 is shown that is a rigid, light, plastic elongated cylindrical body 42 having a forked support member 44 that is spread apart like a wishbone shape. Between the wishbone support members 44, a user inserts a fibrous strand 10 that contains the marking material that can rub off on the certain tooth areas between the teeth. The purpose of the implement 40 is to allow the dentist to more easily apply the fibrous strand 10 between the teeth for marking purposes rather than trying to do it by holding the strand between the fingers. The operation of the implement 40 in FIG. 5 is similar to the application of dental floss but, in this case, the reconstructive dentist is using this implant marking to find the high spots 18 on restoration 16.

Referring now to FIG. 5, a second alternate implement 50 is shown that includes an elongated thin, plastic or rigid body 52 which has wishbone shaped support members 54 and 56 at both ends of the tool. With the tool shown in FIG. 5, at one wishbone end 54, the fibrous strand 10 is applied and connected between the wishbone support members 54 and held tauntly. At the other end, three fibrous strands 10 are applied and also connected to wishbone ends 56 on tool or implement 50. Using the tool 50 shown in FIG. 5, the dentist can use either end for the appropriate implant marking for proper spacing.

Use of the novel combined fibrous strand marker disclosed herein obviates the additional step, in the process of inserting a dental restoration of, separately locating any raised areas on the interproximal surfaces of said restoration by combining the aforementioned step with the already necessary step of passing a thin strand of fiber through the interproximal space between the natural teeth and the restoration.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A marking floss for marking undesired raised areas on the interproximal surfaces of a dental restoration, comprising:
an elongated flexible strand adapted to be moved through interproximal spaces in a mouth, a non-saliva soluble marking material dispersed along said strand for indicating any undesired raised areas to be reduced by sanding.

2. The marking floss of claim 1, wherein said marking material is comprised of a food coloring capable of adhering to porcelain based material.

3. The marking floss of claim 1, wherein said marking material is comprised of a powdered carbon composition.

4. A method of marking undesired raised areas on interproximal surfaces of a dental restoration, comprising the steps of:
fabricating a preparation from an impression of a patient's dental structure in the vicinity where the restoration is to be installed;
placing the restoration upon the preparation to simulate a finished insertion in the patient's dental structure;
passing a flexible fibrous strand impregnated with a marking material between said interproximal surfaces in order to so mark any such raised areas;
removing the restoration from said preparation and reducing any raised areas to a smaller size;
replacing the restoration on the preparation and repeating the step of passing the strand between said interproximal surfaces to mark any remaining raised areas; and
inserting the properly sized restoration onto a preparation in the patient's mouth.

5. The method of claim 4, wherein said marking material is a food coloring capable of adhering to porcelain based material.

6. The method of claim 4, wherein said marking material is a powdered carbon composition.

7. A dental restoration detecting and marking device and a handheld tool comprising:
flexible, fibrous strand sized to fit within the interproximal spaces in a human mouth, said strand carrying thereon a marking material for indicating any undesired raised areas on the interproximal surface of a dental restoration; and
an elongated narrow rigid tool that includes at least one wishbone shaped support member disposed at one end, said wishbone shaped support member having sufficient space and having a means for receiving and attaching said flexible fibrous strand between the wishbone support members, the tool being useable by a dentist to manipulate the fibrous strand within the interproximal spaces in a human mouth.

8. A device as in claim 7, including:
said tool including a second wishbone shaped support member at its opposite end from said first wishbone shaped support member, said second wishbone shaped support member including a means for attaching a plurality of fibrous strands of marking material mounted between the wishbone shaped support members, said plurality of strands being sized to fit along its width within the interproximal shapes in a human mouth and said plurality of strands having marking material on fixed areas for indicating any undesired raised areas on the interproximal surface of dental restoration.
